(19) United States
(12) Patent Application Publication
(10) Pub. No.: US 2019/0355069 A1
(43) Pub. Date: Nov. 21, 2019

(54) Methods and online systems for conducting participant owned, managed, and marketed perpetual competitions utilizing dynamic ranking models and forming social networked marketplaces and economies

(71) Applicants: Philip Baker, Golden, CO (US); Steven Taylor, Overland Park, KS (US)

(72) Inventors: Philip Baker, Golden, CO (US); Steven Taylor, Overland Park, KS (US)

(73) Assignees: Steven Taylor, Overland Park, KS (US); Philip Baker, Golden, KS (US)

(21) Appl. No.: 15/983,089

(22) Filed: May 17, 2018

(51) Int. Cl. G06Q 50/00; G06Q 10/06; G06Q 40/04; G06Q 30/02

(52) U.S. Cl. CPC G06Q 50/01; G06Q 10/0639; G06Q 30/02; G06Q 40/04; G06Q 10/063114

(57) ABSTRACT

This invention includes original systems and methodologies required to conduct perpetual online competitions within social networked marketplaces and economies. Among these systems and methodologies are: perpetual competition-based earnings model, Judges' ranking expiration and devaluation, Judges' ranking upvaluation, and perpetual competition-based business entities and exchanges. The first three inventions are intended to motivate and incentivize four groups of competition participants: Organizers, Contestants, Judges and Followers. The fourth invention provides entrepreneurs the systems and methods for creating a multifaceted business entity within the framework of an online social platform. All inventions function in tandem to form a dynamic and endlessly evolving competitive environment to maximize entertainment value and business development opportunities.

### BACKGROUND OF THE INVENTION

Perpetual competition-based earnings model:

All competitions will have Organizers, Contestants, Judges, Followers, and defined rules of engagement that include methods for judging Contestants participating in the competition. A standard competition has a finite time period in which the competition is conducted. Competitions are designed and created by Organizers who are expected to promote their competition(s). Competitions typically have Contestants who pay entrance fees to compete in the competition. Most competitions have Judges who vote or rank the Contestants within the competition and Followers who follow a competition or Contestant and may “Like” their choices but choose not to rank them.

Perpetual competitions are defined as a continuous series of repeating standard competitions. A perpetual competition may, or may not, have an ultimate completion date. In a perpetual competition, existing Contestants may be required by the Organizer to renew their entrance/competition fees at predetermined intervals in order to remain active within a competition, New Contestants choose to enter into the current standard competition. Contestant rankings within perpetual competitions are dynamically tallied for each standard competition and perpetually throughout the series of all future standard competitions. Organizers perpetually allocate earnings from each standard competition to the top-ranked Contestants. Organizers incur various levels of administrative and advertising expenses to conduct and promote the competition. The pool of Judges for competitions may be variable throughout the perpetual competition.

Ranking Expiration and Devaluation:

All competitions have Organizers, Contestants, Judges and Followers. The Organizer of a competition has typically created said competition and defines the rules of engagement for that competition. Contestants are typically individuals who have paid a predetermined entry fee in order to compete in said competition. Judges are typically individuals who enter the social network in order to rankings their preferred Contestant entry. Followers are typically individuals who have entered the social network and have chosen to follow competitions and Contestant but do not vote. They do, however, express their opinions via “Likes”.

All competitions use either objective methods (e.g., 100-meter race) or subjective methods (e.g., best painting, best movie, etc.) when determining the winner of a competition. A standard competition has a finite time period in which the competition is conducted, and Judges vote one time and their rankings are not devalued. In a standard subjective competition, Contestants compete, and Judges rank those Contestants of the competition based on personal opinions, interpretations, points of view, emotions or judgment.

Perpetual competitions are comprised of a repeating series of standard competitions. The pools of Judges in a perpetual competition are dynamic and fluid. Subjective rankings provided by those Judges can be contemporaneous and short-lived. Rankings in a perpetual competition must be able to react to new Contestants entering into the competition; maintain integrity in the overall voting system and be reactive to the turnover that exists in the pool of Judges for the ongoing perpetual competition.

An example of a purely perpetual competition is a common marketplace or stock market. Here, the Contestants; otherwise known as the sellers, enter a marketplace (created by an Organizer) to compete with goods or services; while the Judges, otherwise known as the buyers, will essentially vote through the act of purchasing or investing in the goods and services offered in the marketplace.

The challenge with conducting a perpetual online competition—while using subjective methods of judging, is to utilize effective systems and methods for aging, or expiring the historical voting or rankings captured within each standard competition of the overall perpetual competition. By keeping the rankings fresh, active and current a perpetual competition will be longer lasting, more relevant, and freely competitive.

Ranking Upvaluation:

A successful perpetual competition requires the active participation of an Organizer(s), Contestants, Judges and Followers. Judges may be motivated to participate in a perpetual competition by a combination of factors including, but not limited to, the following: personal/professional loyalty to a Contestant; pure entertainment value of participating in a competition; desire to enrich themselves through the consumption of digital content; desire to influence the outcomes of a competition through their ranking efforts; desire to be recognized and, perhaps, followed by Followers, for their rankings, and a desire to be a highly-ranked Judge based on accumulated competition reward points.

To maximize the efficacy and entertainment value of a competition Judges need to keep their rankings fresh, comprehensive and frequently updated so that newly introduced competitive submissions from new Contestants are reviewed and ranked as appropriate. The incentives previously listed are intended to drive this behavior.

To further maximize Judges' active engagement the Ranking Upvaluation invention was created. This system and methodology enables an Organizer to apply a flexible Ranking Upvaluation Multiplier to a Judge's ranking of a specific Contestant if that ranked Contestant was initially ranked by the Judge when that Contestant was not listed on the Top-ranked Contestants' List and later rose in the summary rankings to be on the Top-ranked Contestants' List. The longer the duration is between the Judge's initial ranking of the non-ranked Contestant and the point in time in which the Contestant attains a position on the Top-ranked Contestants' List will result in one reward point for each day. The total number of subsequent days will be multiplied by the Ranking Upvaluation Multiplier as determined by the Organizer.

The express purpose of this invention is to reward Judges to seek out and find lesser viewed and non-ranked Contestants within a given competition as early as possible. Earned reward points can be used by a Judge as entry fees in competitions and other purposes as determined by the Organizer.

Perpetual competition-based business entities and exchanges:

The basis of this invention is deeply rooted in the well-accepted belief that online social networks provide ideal platforms for participants to freely share ideas, thoughts and content, which allows valuable creativity to grow and flourish. Online social platforms are ideal marketplaces for participants to find commonalities, assess the performance of each participant and build incremental equity in terms of creating a following of other participants, which, in turn, reflects upon valuation.

This invention is firmly grounded in the belief that everyone possesses a skill or talent at some level that provides value to someone else. At the same time, outside of the social networking environment, many of these individuals can find it difficult to translate their talents and skills into entrepreneurship. They may either lack the business knowledge, experience, or acumen to develop and market their skills and talents into consumable products. Traditional markets may have high barriers for entry, or conditions of imperfect competition that may limit the success of an entrepreneur.

By blending the features of competitions with the features of a social network, an entrepreneurial environment is created where participants demand entertaining content or thought-provoking ideas from other talented entrepreneurs. The supply and demand of content builds the framework for a business environment within the social network. These social networked businesses are subject to all of the same competitive pressures that exist in traditional marketplaces, but the barriers of entry for participating in social networked competitions are greatly reduced and the sought after capitalistic rewards are far more easily attained, even for entrepreneurs without much business experience.

### SUMMARY OF THE INVENTION

Perpetual Competition-Based Earnings Model:

The aforementioned invention contains the systems and methods for allocating monies earned by stakeholders who participate in online competitions conducted within a social networking environment.

Organizers configure competitions by predefining entrance and competition fees and how financial winnings are allocated to Contestants and affiliated Organizers. Organizers configure perpetual competitions by predefining the duration between each standard competition. As with all competitions, Organizers must promote these competitions to the broader social networking environment in order to attract Contestants, Judges and Followers to their competitions. Organizers compete against other organized competitions across the social network by developing a following for their competition; thereby promoting greater interest across the social network and encouraging the entrance of more Contestants; ultimately increasing the value of the competition. Organizers incur expenses when promoting competitions; therefore, they must communicate any administrative fees, which will be taken during the allocation of competition earnings. Organizers can affiliate with other social network groups and category Organizers, thereby sharing in administrative and promotional costs but also allocating a portion of competition earning to those affiliates.

Contestants enter into the perpetual competition(s) of their choice by agreeing to the preconfigured rules of engagement of the competition, paying the predefined entrance fee, and uploading content into the virtual electronic competition. Top-ranked Contestants of the competition receive financial winnings based on the predefined allocations configured by the Organizer. Contestants can choose to perpetually compete in the competition by continuing to renew their entrance/competition fees for the competition as required by the competition's Organizer. Contestants can independently promote and advertise their content in order to develop Followers across the social network.

Judges are motivated to evaluate competitions based on their own personal interests, preferences, tastes, and entertainment value of content provided by Contestants competing in those competitions. Judges maintain personal ranking boards for any number of followed competitions. It is the summation of the ranking boards for all Judges of a competition that defines the winners of any competition on the social network.

Judges and Followers are consumers of content. These participants demand the highest levels of quality for content competing across the social network. Contestants are financially motivated to supply Judges and Followers with the most highly entertaining content. Organizers are monetarily incented to find and attract talent to compete in their competitions.

Ranking Expiration and Devaluation:

The aforementioned invention contains the systems and methods for maintaining Contestants' rankings in an electronic online perpetual competition. All Organizers, Contestants, Judges and Followers that participate in these perpetual competitions are contained within a social networked environment. A perpetual competition is a continuous series of standard competitions that seamlessly start and stop, then restart and re-stop. The competition's Organizer pre-configures the duration of each standard competition within the perpetual competition. At the conclusion of each standard competition, the Judges' rankings are tallied, and Contestants are declared winners for that period. Immediately after closing an old standard competition, a new standard competition is opened, thereby simulating an ongoing perpetual competition.

Throughout the perpetual competition, Judges maintain rankings for favorite Contestants in the competition. These rankings are tallied, and winners are awarded as predefined by the duration period for each standard competition. The pool of Judges that follow a perpetual competition can be dynamic and ever changing. Any number of Judges can follow any number of competitions and maintain rankings for any number of Contestants who participate in multiple perpetual competitions. Under these conditions, perpetual competitions require unique systems and methods that not only award prizes to the top-ranked Contestants, but also keep rankings current and fresh for existing Contestants and to promote the entrance of new Contestants into the competition. The following two methods were invented to promote ranking integrity within a perpetual competition under the dynamic conditions that exists in a social networking environment. These two methods coexist to calculate a final ranking awarded by any Judge to any Contestant during a specific standard competition period.

The first method devalues each Judge's rankings in the competition based on the ranking position of each Contestant evaluated in the competition. The higher positioned Contestant rankings of a competition are devalued less than lower positioned rankings. Assuming that each Judge of a competition ranks the top-10 Contestants in a competition, then a full vote (1.0) would be assessed to each Judge's top Contestant. Votes for each lower-ranked Contestant would be devalued by one-tenth of a vote, until a one-tenth (0.1) vote is awarded to each Judge's tenth-ranked Contestant. Only Contestants that are ranked on a Judge's top-10 list would receive votes (or portions of a vote).

The second method devalues each Judge's rankings in a competition based on time since the rankings were last refreshed. If a Judge ranked Contestants in a competition within the current period relative to the number of devaluation periods, then the Judge's rankings would not be devalued using this method. If a Judge has not re-evaluated Contestant rankings for any number of periods prior to the current period, then the Judge's rankings would be devalued using this method. The velocity of ranking devaluation is relative to the number of devalue periods configured into the competition. If the devalue period is “15-days” then, for example, rankings for each Contestant would be devalued by one-fifteenth for each period that the rankings are unchanged.

These two methods would coexist with each other to calculate the final ranking awarded by any Judge to any Contestant participating in the competition. These two ranking devaluation methods have the effect of incentivizing Judges to keep their competition's rankings relevant and current, while also promoting new Contestants to join competitions even though existing Contestants may have a more established following. These methods and systems provide the needed structure for conducting a perpetual competition within a social networking environment.

Ranking Upvaluation:

The aforementioned invention contains the systems and methods for calculating the upvalued Judge's ranking captured during an online perpetual competition. The competition's Organizer pre-configures the multiplicative upvaluation percentage of each standard competition within the perpetual competition. At the conclusion of each standard competition, the Judges' rankings are tallied, and Contestants are declared winners for that period. Immediately after closing an old standard competition, a new standard competition is opened, thereby simulating an ongoing perpetual competition.

Throughout the perpetual competition, Judges maintain rankings for favorite Contestants in the competition. These rankings are tallied, and winners are awarded as predefined by the duration period for each standard competition. To ensure that new Contestants are motivated to enter a competition it is critical that Judges are incentivized to seek out and rank Contestants that are not on the current top-ranked Contestants' list. Under these conditions, perpetual competitions require unique systems and methods that drive the aforementioned Judge's behavior. The following method was invented to recruit and promote a highly engaged population of Judges and ensure a dynamic population of Contestants within a perpetual competition.

The method for upvaluing a Judge's ranking begins with the Organizer determining the “Upvalue Talent Finder Factor” percentage for a competition. This multiplier will increase the points the Organizer awards for each Judge's ranking based on several factors: 1) The number of days between when the Contestant was added to the ranking board and the current date, 2) Was the Contestant in the top-ranked Contestant list when ranked by the Judge? and 3) Is the Contestant in the top-ranked Contestant list at the end of the current standard competition?

All Judges' rankings are, by default, initially awarded one point by the competition's Organizer. The upvalution multiplier is applied, for example, to a rank when the Judge has voted for a Contestant who was not on the top-ranked Contestant list at the time of the ranking and which, later, rises to the current top-ranked Contestant list. Specifically, the number of days between the current date and the date the ranking was initially cast will equal the additional points awarded to the Judge's ranking multiplied by the upvaluation multiplier. The number of standard competitions in which the upvalution multiplier is applied to is determined by the competition's Organizer.

The points earned by Judges are provided by the competition's Organizer and will be considered a promotional cost incurred by the Organizer. These points may be used by the Judges as credits to be used as monetary offsets against future entry fees into competitions, or other uses as determined by the Organizer.

This upvaluation rank multiplier provides the incentives to the Judges to seek out and rank Contestants who are not currently on the top-ranked Contestants' list, which ensures that the top-ranked Contestants' list is constantly refreshed with new talent. This provides the secondary benefit of making the Organizer's competition more attractive to new Contestants which, in turn, makes the competition more attractive to new Judges and Followers.

Perpetual Competition-Based Business Entities and Exchanges:

The aforementioned invention contains the systems and methods for creating businesses and business commerce networks for establishing various business roles and relationships and for hosting business financing models and trading exchanges all within a competition-based social networking environment.

Within the competition-based social network, entrepreneurs and business owners can establish a business profile by disclosing any tax or business filing information (i.e., SSN, EIN, etc.). The business owner can also disclose any intellectual property (e.g., patents, copyrights, trademarks) that pertains to published content owned by this business. After registering the business, the social network is responsible for providing a perpetual balance sheet and income statement, which will allow the business to monitor financial performance. Assets, liabilities, owner's equity, and income are perpetually updated and reported to each business on the social network.

Within a competition-based social networking environment, businesses can choose to compete in competitions; promote contestants, competitions, communities and categories; and conduct business commerce using various methods. The success or failure of all businesses within a competition-based social network are ultimately based on the quality of content and ideas brought forth within competitions and the demand for this content by other consumers and voters participating on the social network.

This competition-based social network is to be deployed internationally, so each business profile in the competition-based social network must establish a base currency dependent upon the tax jurisdiction of the business. Competitions must also establish a base currency dependent upon the tax jurisdiction of the owning business once the competition is created. The social network will facilitate currency conversions on business transactions between owners of businesses and the competitions as well as products or services that are purchased or sold by other business owners on the social network. All business transactions are subject to currency exchanges published by the host (aka the owner of the social network). Most generally accepted currencies should be exchanged on this structured environment. Crypto-currencies and other yet-to-be-developed currencies may also be utilized.

The success and growth of an online competition-based business can be further optimized if others can have a participatory role within the social networking experience. Organizers and Contestants typically create competition-based businesses; however, other roles exist within this social network to support business decisions and provide funding that may be needed to meet objectives of any business.

Bankers can supply loans or other debt instruments to Organizers, Contestants, and others in the social network. This credit can be used to promote future competitions, fund entrance fees, and expand working capital for future business commerce.

Investors can supply capital to businesses through trade exchanges on the social network. Businesses operating within a purely competition-based revenue model provide an ideal environment for investors seeking to optimize their return on investment.

Service Providers may not participate in competitions; however, they can provide expertise and support to competition-based businesses and others within the social networking environment. Services they can offer include business operations, decision management, legal, and accounting services.

The social network will host and facilitate debt and equity trade exchanges across the competition-based social networking environment. All trades and transactions will be electronically processed, and all investment exchanges are perpetual and always open. The social networking host will perpetually calculate financial success ratings (i.e., credit ratings) for each business on the social network.

To facilitate the use of debt markets, equity markets, and professional services within an open social networking environment the business performance of competition-based businesses must be fully transparent by displaying balance sheets and income statements to all debtors and investors and regulate how companies can be dissolved. Stock tickers and analytics should be provided for all debt markets, trade exchanges and business equity shares traded on exchanges within the social networking environment.

Specifically, for equity exchanges rules and regulations would be required to maintain a fair market that prevents misrepresentation of initial offerings and manipulation of shareholder equity. Each trade exchange must perpetually calculate and publish the value of projected worth (e.g., market capitalization value) for any online business that chooses to offer shareholder ownership on trade exchanges. Businesses should be restricted from issuing new shares that extend the company beyond its current calculated worth.

Shareholders should understand that their rights as an owner are limited. Shareholders invest in non-voting ordinary shares with no powers to directly remove owners of companies. However, their voting rights do enable them to replace contracted professional managers of the company. If the business dissolves on the social network, company assets must first be used to pay company debts before assets are distributed to shareowners. While shareholders have limited ownership control over a business, shareholders can, collectively, exercise significant control over a business by providing testimonial reviews and rankings on the social network. Business owners are competing to preserve a positive reputation on the social network as a means of increasing the value of their business.

### BRIEF DESCRIPTION OF THE DRAWINGS

Perpetual competition-based earnings model:

FIG. 1 illustrates an example of the motivations and direct and indirect influences of all participants of a competition conducted on a social networking environment.

FIG. 2 illustrates the relationship between the competition Organizer and other affiliated Organizers within the social network.

FIG. 3 illustrates how entrance fees accumulate through competitions and are allocated to the top-ranking Contestants and Organizers.

Ranking Expiration and Devaluation:

FIG. 4 illustrates how one competition's Organizer configured an online perpetual competition to devalue aged or expired rankings.

FIG. 5 illustrates how the rankings from one Judge are devalued by the “position of ranking” and not by the “age since last ranking” (today).

FIG. 6 illustrates how the rankings from one Judge are devalued by the “position of ranking” and by the “age of last ranking” (5 devaluation periods ago).

FIG. 7 illustrates how the rankings from one Judge are fully devalued by the age of last ranking (15 devaluation periods ago) because this exceeds the number of devaluation periods.

Ranking Upvaluation:

FIG. 8 illustrates an example of how an Organizer might configure a perpetual competition in order to incentivize Judges to search for lesser known but talented Contestants entered into this competition.

FIG. 9 illustrates an example of how points are awarded in a manner that incentivizes Judges to rank top Contestants while also searching for new talented, but undiscovered, Contestants which are entered into their own personal ranking board before appearing on the consensus ranking board of the standard competition.

FIG. 10 illustrates an example of how points are recalculated and awarded to the next standard competition from the competition illustrated in FIG. 9.

Perpetual Competition-Based Business Entities and Exchanges:

FIG. 11 illustrates an example of how different types of businesses can interact with other business; with various types of market exchanges and services; and using multiple features provided within a competition-based social networking environment.

FIG. 12 illustrates an example of a balance sheet for the business entity of an Organizer conducting business within the framework of a competition-based social networking environment.

FIG. 13 illustrates an example of a balance sheet for the business entity of a Contestant conducting business within the framework of a competition-based social networking environment.

FIG. 14 illustrates an example of a balance sheet for the business entity of an Investor conducting business within the framework of a competition-based social networking environment.

FIG. 15 illustrates an example of a balance sheet for the business entity of a Banker conducting business within the framework of a competition-based social networking environment.

FIG. 16 illustrates an example of a balance sheet for the business entity of a Service Provider conducting business within the framework of a competition-based social networking environment.

### DETAILED DESCRIPTION OF THE DRAWINGS

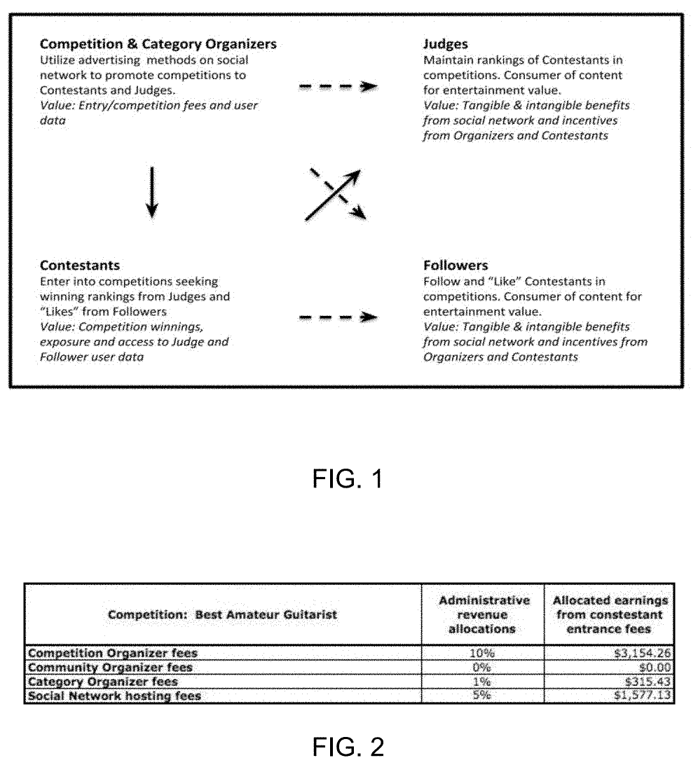

Embodiments of earnings allocation for an online electronic competition according to the present invention will be described below with reference to FIGS. 1-16.

Perpetual Competition-Based Earnings Model:

FIG. 1 illustrates the motivation of all participants of a competition conducted on a social networking environment. Competition and Category Organizers are motivated to attract interest in competitions in order to collect more entrances fees and access to Judge, Follower and Contestant user data. Contestants are motivated to compete with high quality content in order to increase rankings, awareness, access to Judge and Follower user data and winning earnings. Judges and Followers are motivated to search, consume, and provide feedback on competing content that provides the highest entertainment value in order to enjoy the tangible and intangible benefits of the social network and any incentives provided by Organizers and Category Owners.

FIG. 2 illustrates how a Competition Organizer for “Competition: Best Amateur Guitarist” has affiliated with another Organizer in the social network. In this example, the Competition Organizer has affiliated with a Category Organizer (possibly named “Music: Guitar”); granting a portion of competition earnings, but also in sharing the administrative and promotional costs of the competition and the affiliated category. The Category Organizer requires a 1% fee of all earnings for this competition to be affiliated with this category. This example also demonstrates that the Competition Organizer has chosen to not affiliate with any community.

By pre-configuring these affiliations, the Competition Organizer is effectively communicating a marketing plan for an organized competition. Contestants may evaluate which competitions are most beneficial based on these category or community affiliations. Judges and Followers on the social network can also be attracted to certain competitions based on their affiliations with certain categories and communities.

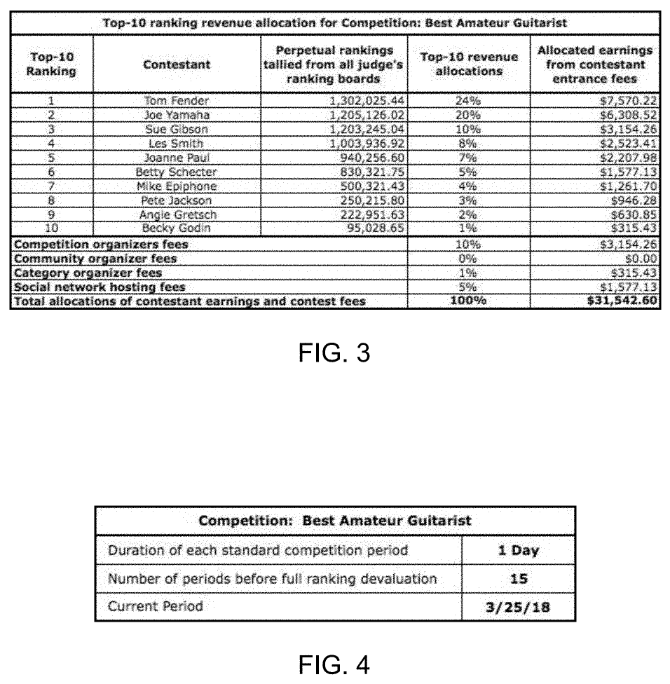

FIG. 3 illustrates how entrance fees; accumulated through competitions, are allocated to top-ranking Contestants and to the various Organizers involved or affiliated with this competition. Competition Organizers must predefine the revenue allocations that will be awarded to top-ranked Contestants. In this example, the Competition Organizer established an allocation which awards 24% of all earnings to the top-ranked Contestant followed by a declining allocation to the next eight Contestants and ending with a 1% allocation to the tenth-ranked Contestant.

Competition Organizers can develop allocation strategies that will attract the type and quality of Contestants that will increase the value of those competitions. Contestants can develop their own strategies about which competitions will increase their earning potential. Judges and Followers on the social network benefit by having many entertainment choices amongst all the competitions to consume.

Ranking Expiration and Devaluation:

FIG. 4 illustrates one example of the configuration used to devalue competition rankings within a social networking environment. The configuration used for this perpetual competition defines the duration of each standard competition as “1 Day”, therefore rankings are tallied, and new winners are awarded on a daily basis. Rankings from each Judge are devalued or expired over the course of the predefined “devalue periods”. The configuration of this competition defines the ranking devalue period as 15 days. Therefore, in 15 days, a Judge's rankings, which have not been re-evaluated within 15 days, will be fully devalued.

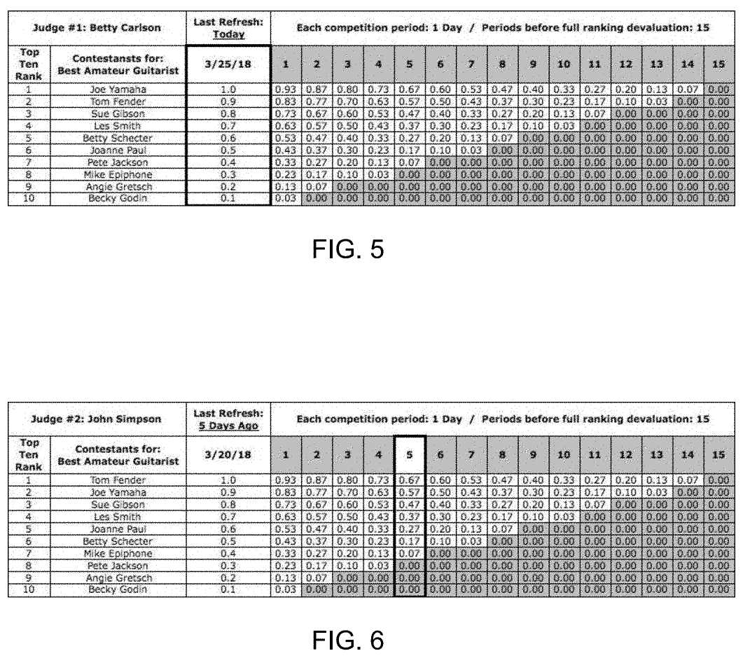

FIG. 5 illustrates one example of how the “Best Amateur Guitar” competition rankings by Judge Betty Carlson are only impacted by the “position of ranking” devaluation method. In this example, each standard competition was defined as “1 Day” and Judge #1 Betty Carlson last refreshed her perpetual rankings in the current period; therefore, her rankings are not impacted by the “age since last ranking” devaluation method. This table primarily demonstrates how top-ranked Contestants are devalued less than lower-ranked Contestants when using the “position of ranking” devaluation method.

FIG. 6 illustrates one example of how the “Best Amateur Guitar” competition rankings of Judge John Simpson are devalued by the “position of ranking” method and by the “age since the last ranking” method (i.e., 5 devaluation periods ago). In this example, each standard competition was defined as “1 Day” and Judge #2 John Simpson, last refreshed his rankings 5-devaluation periods ago, therefore the strength of his rankings is impacted by both devaluation methods: (1) “position of ranking” and (2) “age since the last ranking”.

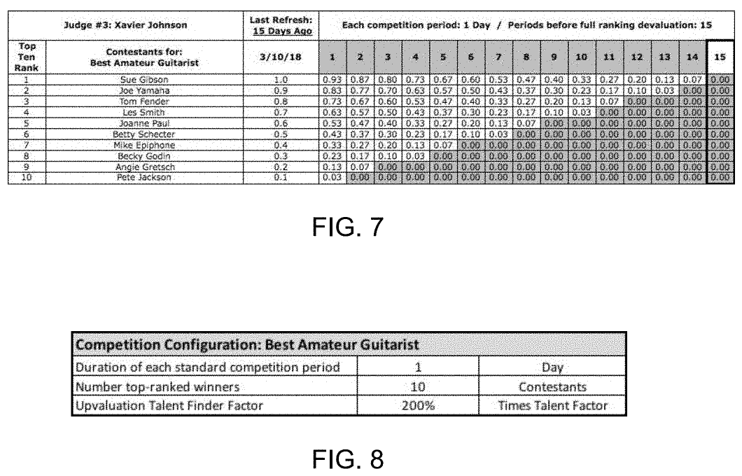

FIG. 7 illustrates one example of how the “Best Amateur Guitar” competition rankings of Judge Xavier Johnson are fully devalued by the “position of ranking” method. In this example, the last ranking refresh was greater than, or equal to, 15 devaluation periods. Judge #3 Xavier Johnson, last refreshed his perpetual rankings 15 days ago, therefore the strength of his rankings has been fully devalued and will not contribute to the rankings of this competition.

Ranking Upvaluation:

FIG. 8 illustrates an example of the how the Organizer has configured a perpetual competition called “Best Amateur Guitar” in order to award points to participants for judging Contestants. If the Organizer configures a high “Upvaluation Talent Finder Factor”, then they will reward those Judge's that search for the lesser known but talented Contestants entered into this competition. Organizers can configure perpetual competitions to award bonus points to those Judges that have not allowed the ranking boards to expire [See FIG. 4.]

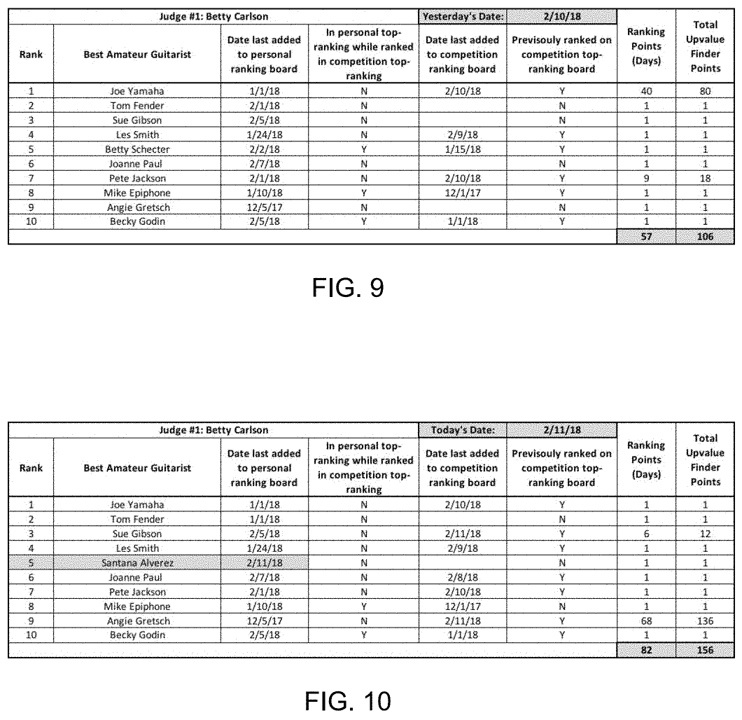

FIG. 9 illustrates an example of how and when Judge Betty Carlson ranked contestants on the personal ranking board of a competition called “Best Amateur Guitarist”. When Betty Carlson ranked these contestants, some already had received top-rankings by the competition, while others had not. For example, Contestant Joe Yamaha received a top-ranking vote from Betty while Joe Yamada was not an overall top-ranked Contestant by the perpetual competition ranking board. Therefore, once it is the consensus of all Judges that Joe Yamada is a top-ranked contestant, then Betty is rewarded with “bonus points” calculated from the number of standard competition periods on Betty's ranking board while not top-ranked on the perpetual competition ranking board multiplied by the “Upvaluation Talent Finder Factor”. Organizer's promote reward programs to create loyalty from Judges and Followers who can later receive discounts to enter competitions as Contestants or other value-add services as determined by the Organizer. After a Contestant is ranked by the perpetual competition ranking board, Judges will continue to receive nominal awards for each standard competition period in the perpetual competition.

FIG. 10 illustrates an example of how loyalty points for Judge Betty Carlson were recalculated and awarded to the next standard competition period FIG. 9. On the previous day, consensus of all Judge's was that Contestants Joe Yamaha and Pete Jackson were top ranking contestants, and Betty Carlson received Total Upvalue Finder Points” as a reward for discovering talent before the consensus rankings. Going forward, nominal reward points will be rewarded to Betty Carlson for maintaining Joe Yamaha and Pete Jackson on her ranking board. This figure also illustrates that Betty Carlson replaced Contestant Betty Schecter with Contestant Santana Alvarez on her ranking board for the “Best Amateur Guitarist” competition. If Santana Alvarez is ranked on the consensus competition ranking board, then Betty Carlson will receive additional “Total Upvalue Finder Points” as a reward for finding new talent entered into the competition.

Perpetual Competition-Based Business Entities and Exchanges:

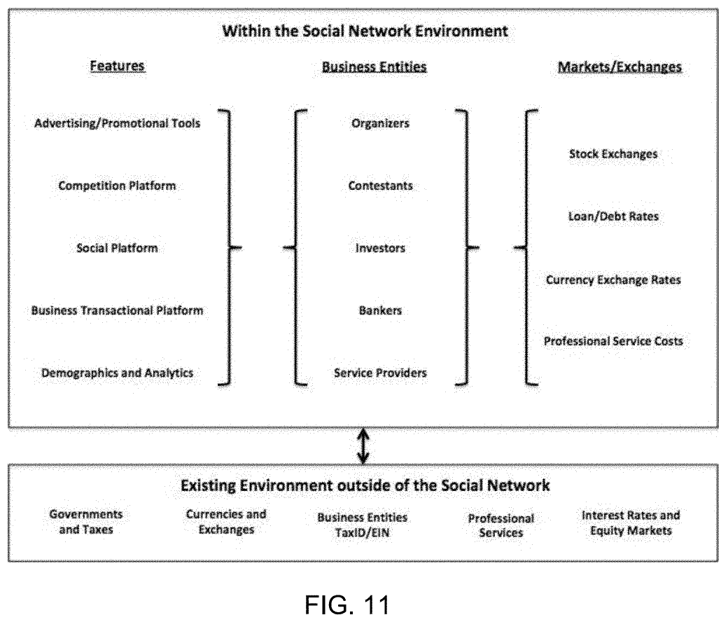

FIG. 11 illustrates one example of how different types of businesses can interact with other business with various types of market exchanges and services, and using multiple features provided within a competition-based social networking environment. While Organizers and Contestants are promoting and competing in competitions, Investors, Bankers, and Service Providers utilize the features and infrastructure of the social network to provide financing and professional services.

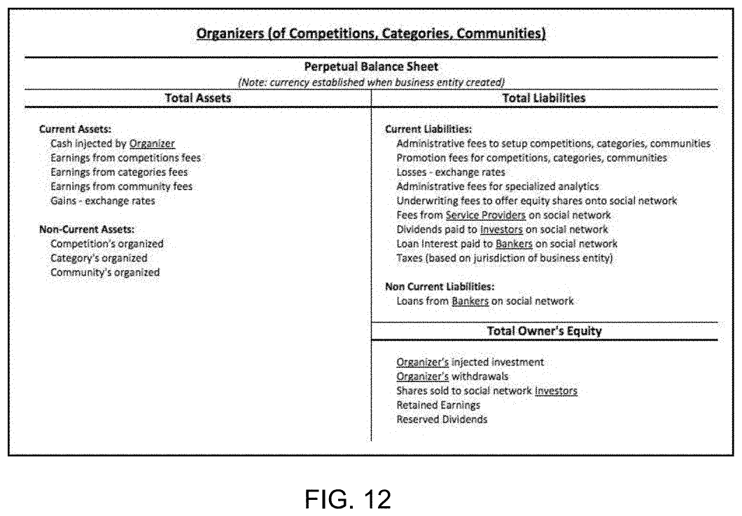

FIG. 12 illustrates one example of a balance sheet for the business entity of an Organizer conducting business within the framework of a competition-based social networking environment. Organizers accumulate assets by receiving portions of the earnings of competitions. Liabilities include administrative fees used to create and promote competitions, costs for services and financing (debt or equity), losses for exchange rate conversions and taxes.

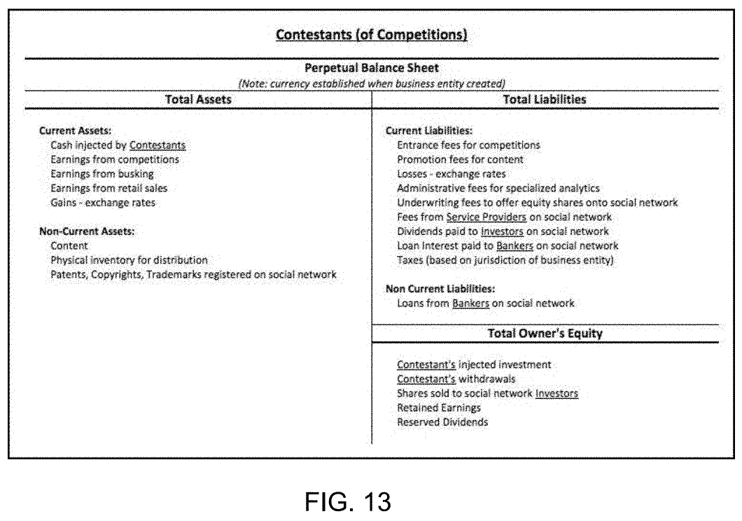

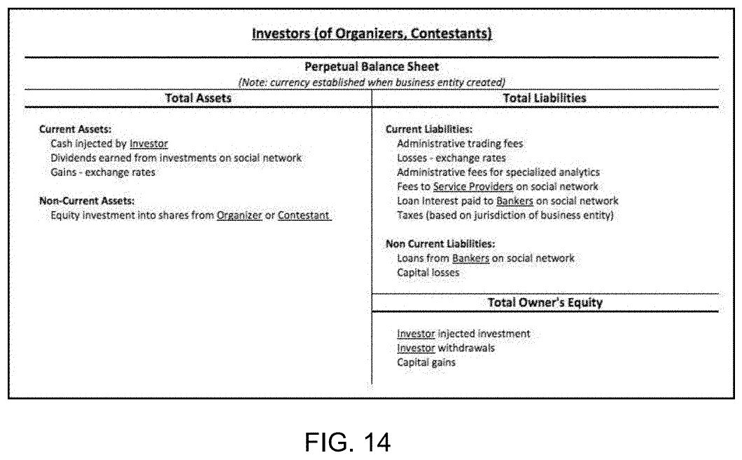

FIG. 13 illustrates one example of a balance sheet for the business entity of a Contestant conducting business within the framework of a competition-based social networking environment. Contestants accumulate assets by receiving earnings from competitions, from busking, or through retail sales. Liabilities include entrances fees for competitions, costs for services and financing (debt or equity), losses for exchange rate conversions and taxes.

FIG. 14 illustrates one example of a balance sheet for the business entity of an Investor conducting business within the framework of a competition-based social networking environment. Investors accumulate assets by investing in appreciating businesses and receiving dividends on those investments. Liabilities include trading fees, costs for services and financing (debt or equity), losses for exchange rate conversions and taxes.

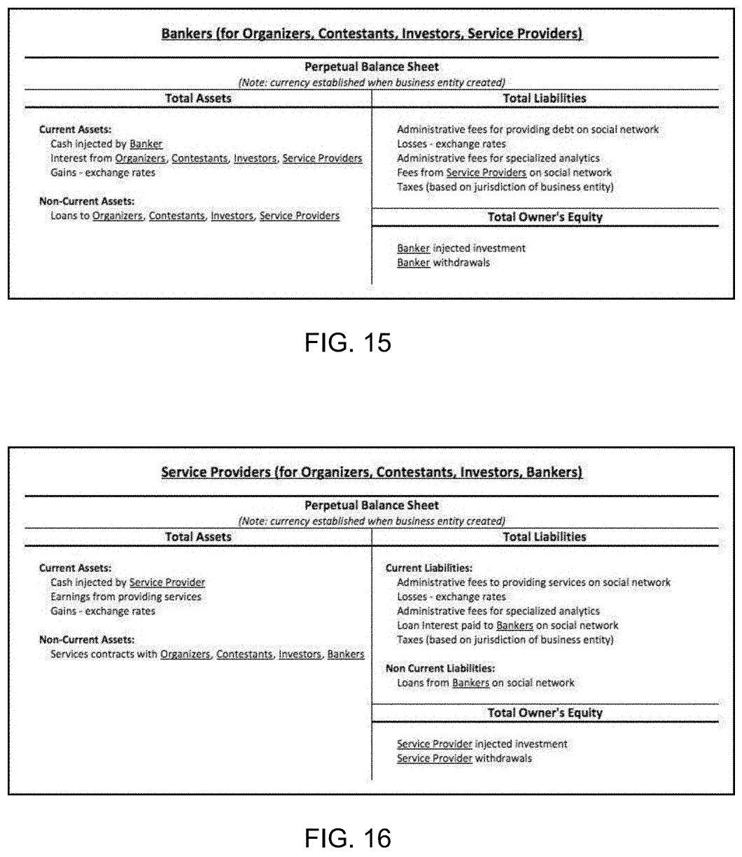

FIG. 15 illustrates one example of a balance sheet for the business entity of a Banker conducting business within the framework of a competition-based social networking environment. Bankers accumulate assets by lending to other participants in the social network and receiving interest payments on those loans. Liabilities include administrative fees, losses for exchange rate conversions and taxes.

FIG. 16 illustrates one example of a balance sheet for the business entity of a Service_Provider conducting business within the framework of a competition-based social networking environment. Service Providers accumulate assets collecting fees for professional services provided to other participants in the social network. Liabilities include administrative fees, losses for exchange rate conversions and taxes.

1. Perpetual competition-based earnings model:
Invention provides a computer-implemented method for conducting perpetual competitions within an online social networking environment; creating social economies for its participants, comprising of:
Organizers (who create user-defined categories and social groupings; creating user-configured perpetual competitions, advertise and promote these economies by utilizing search engine advertising methods);
Contestants (who pay perpetual entrance fees to enter their content into perpetual competitions);
Judges and Followers (who maintain rankings or follow contestants who are participating in perpetual competitions, categories, and communities of their choice);
a dynamic and perpetual distribution of financial value through the allocation of on-going contest winnings operated by means of user-configured on-going competitions within social networking economies.
a social online platform that motivates followers to explore talent, to contribute in the success of other participants, to ultimately promote the discovery of everyone's inherent talents.

2. Ranking expiration and devaluation:
Invention provides a computer-implemented method to age, expire, or devalue a Judge's rankings of contestants competing in perpetual user-configured competitions within the online social networking environment described in claim 1 and comprising of:
devaluation methods of Judge's rankings of contestants in perpetual competitions are “ranking position” (i.e., Top-10) and “age of ranking” (i.e., time since last ranking);
the collective devalued rankings of all Judges are tallied when awarding winners of each standard competition period of any ongoing perpetual competition.

3. Ranking upvaluation
Invention provides a computer-implemented method to upvalue a Judge's select ranking of contestants competing in perpetual user-configured competitions within the online social networking environment described in claim 3 and comprising of:
Organizer pre-configured multiplicative upvaluation percentage variable which multiplies the awarded points earned by Judges for ranking Contestants not currently ranked in the top-ranked Contestants' list.

4. Perpetual competition-based business entities and exchanges:
Invention provides computer-implemented methods to leverage the online perpetual competition-based social economies described in claim 1 and claim 2 in order to create businesses, marketplaces, and exchanges which allow entrepreneurs to freely engage, invest, and trade with others in the social network comprising of:
Any entrepreneur who chooses to participate in these social economies (by creating personal or publicly structured business profiles based on financial and tax jurisdictions);
Bankers (who loan working capital to other participants in the social network);
Investors (who invest and share ownership of publicly structured businesses in the social network);
Service Providers (who provide professional services to other participants in the social networking economy);
A social networking provider that hosts and regulates all business transactions and trade exchange platforms used by the entrepreneur and business participating in this competition based social networking environment.
